(19) United States
(12) Patent Application Publication
(10) Pub. No.: US 2018/0057325 A1
(43) Pub. Date: Mar. 1, 2018

(54) Rolling Motorcycle Stand

(71) Applicant: Richard Anthony Olson, Menomonie, WI (US)

(72) Inventor: Richard Anthony Olson, Menomonie, WI (US)

(21) Appl. No.: 15/254,624

(22) Filed: Sep. 1, 2016

(51) Int. Cl. B66F 5/02

(52) U.S. Cl. CPC B66F 5/02

(57) ABSTRACT

A lightweight yet strong and easy to use, rolling motorcycle stand is provided. The preferred embodiment of the rolling motorcycle stand includes a two lift arms, each with one rotating castor wheel, and a lift assembly, which also includes a rotating castor wheel, connected to the lift arms by a hinge. The stand can be shifted from its lowered configuration to its raised configuration by operating a lever on the lift assembly. The rolling motorcycle stand allows a user to laterally shift or move a parked motorcycle or other motor vehicle.

### BACKGROUND OF THE INVENTION

The invention disclosed herein relates to a rolling motorcycle stand and, more specifically, a rolling motorcycle stand that may be easily moved around on rollers. The present invention provides a rolling motorcycle stand which may be used to allow a user to laterally shift or move a parked motorcycle, thereby allowing for the more efficient use of space.

It is not unusual for a motorcycle to share a garage, or similar parking area, with other vehicles, yard equipment, tools, and many other things that individuals store in garages and similar structures. Typically, garages and other similar parking structures, particularly where the structure is older, have limited accessible room for vehicles. That is, garages and other structures often have a more limited area where vehicles can actually be placed within the garage or similar structure when the vehicle is driven into the structure due to the location and size of the garage door(s). For example, in the case of a one car garage, if a motorcycle is driven into the garage and parked, there often is not sufficient space to also park a car or truck in the garage because it is difficult, when driving the motorcycle into the garage, to park the motorcycle very close to the wall of the garage or similar structure. Therefore, it is desirable to have a motorcycle lift that allows the location of the motorcycle to be shifted slightly, such as closer to the wall of the garage or other structure, after it has been driven into the garage or similar structure in order to create sufficient open space for another vehicle (like a car or truck) to also be parked in the garage or similar structure without the motorcycle being in the way.

While motorcycle stands do exist, the current stands typically come in one of two types. The first is a non-mobile stand that is used to perform maintenance on the motorcycle or to hold the motorcycle upright without the use of the motorcycle's stand. However, since such stands are not mobile, they do not address the problem at issue, which is the parking of the motorcycle interfering with the parking of other vehicles in the structure. The second type of stand is a stand that attaches to the rear wheel of the motorcycle and includes small non-rotating wheels that allows the motorcycle to be move forward or backward without shifting the motorcycle into neutral. While these stands would indirectly allow a motorcycle to steer and turn to move the motorcycle to one side or another while it rolls forward or backward, the stands, due to their fixed wheel, do not allow the stand to be shifted laterally alone (that is, perpendicular to the direction the motorcycle is pointed in). These stands also must be attached to the rear wheel of the motorcycle, such that space is necessary behind the motorcycle to allow the stand to be put into place and rotated downward to lift the rear wheel of the motorcycle off of the surface of the ground. As such, these stands also do not address the issue at hand.

As such, there is an existing need for a motorcycle stand that includes rollers that may be used to laterally shift a parked motorcycle in order to move the motorcycle to a more “out of the way” position in places such as garages.

### BRIEF SUMMARY OF THE INVENTION

It is a feature of the present invention to provide a rolling motorcycle stand that may be used to quickly and easily laterally shift or move a parked motorcycle.

The stand of the present invention comprises two lift arms, each with one rotating castor wheel, and a lift assembly, which also includes a rotating castor wheel, connected to the lift arms by a hinge. The lift arms are slightly angled relative to each other, such that the lift arms can be rolled into position under the wheel more easily and so the stand can be used with motorcycles (or even other vehicles) having different sized wheel and tires. The lift arms are attached to a base assembly, which is then attached to the lift assembly through a hinge. The lift assembly includes a lever for raising and lowering the stand, a lift lock for locking the stand in its raised configuration, and a lift lock release for releasing the lift lock when the user desires to shift the stand back into its lowered configuration.

The lift arms of the stand of the present invention are placed around the front or rear wheel of a motorcycle (or, if the user has two stands, one stand is placed around each wheel), with one lift arm being under the front of the wheel and the other lift arm being under the back of the wheel. The stand is then rolled forward until the lift arms make direct contact with the front and back of the wheel, the lever that is part of the lift assembly is then pressed downward (typically, by the user's foot) which causes the edge of the lift arms nearest to the lift assembly to shift upward, thereby lifting the wheel of the motorcycle off of the surface of the ground and shifting the stand to its raised configuration. The lever is then locked into place with a lift lock, which retains the lift arms in their lifted configuration. The user can then roll the motorcycle in any direction on the castor wheels, including moving the motorcycle directly laterally, such that, for example, the motorcycle can be placed in close proximity to the wall, at a location which would be inaccessible when there is a rider on the motorcycle or when it is being driven into the garage or similar structure. The lift lock is then released, which allows the lift assembly to rotate upward, thereby lowering the edge of the lift arms nearest to the lift assembly to shift downward and place the wheel of the motorcycle back on the surface of the ground and returning the stand to its lowered configuration.

The present invention aims to allow users to make more efficient use of space in places such as garages and the like. More specifically, the stand of the present invention allows a user to move a motorcycle laterally to, for example, move the motorcycle closer to the wall of the garage or similar structure to increase the amount of space available for the parking of other vehicles. The ends of motorcycle can either be shifted laterally individually or, with a pair of stands of the present invention, shifted laterally at the same time (although in that case additional care must be taken to insure that the motorcycle does not tip over sideways since the motorcycle stand will no longer be holding the motorcycle upright).

While the stand of the present invention is typically for use with motorcycles, it can also be used with other vehicles (such as cars, trucks, all terrain vehicles, scooters, and the like) to allow the vehicle to easily be moved around. However, when the stand is used with different vehicles with more than two wheels, it will often require the use of multiple stands at the same time since a single stand will not be sufficient to move the vehicle since the other wheels of the vehicle will hold the vehicle in place.

### BRIEF DESCRIPTION OF THE DRAWINGS

FIG. 1 is a perspective view of the rolling motorcycle stand of the present invention, with the stand in its lowered configuration.

FIG. 2 is a top plan view of the rolling motorcycle stand of FIG. 1.

FIG. 3 is a side elevation view of the rolling motorcycle stand of FIG. 1.

FIG. 4 is an end elevation view of the rolling motorcycle stand of FIG. 1, with the stand shown from the lift lever end of the stand.

FIG. 5 is an end elevation view of the rolling motorcycle stand of FIG. 1, with the stand shown from the wheel lift end of the stand.

FIG. 6 perspective view of the rolling motorcycle stand of FIG. 1, with the stand in its raised configuration.

FIG. 7 is an exploded view of the portable stand of FIG. 6.

FIG. 8 perspective view of the rolling motorcycle stand of FIG. 1, with the stand in its raised configuration and showing the use of the stand together with a motorcycle.

### DETAILED DESCRIPTION OF THE PREFERRED EMBODIMENT(S)

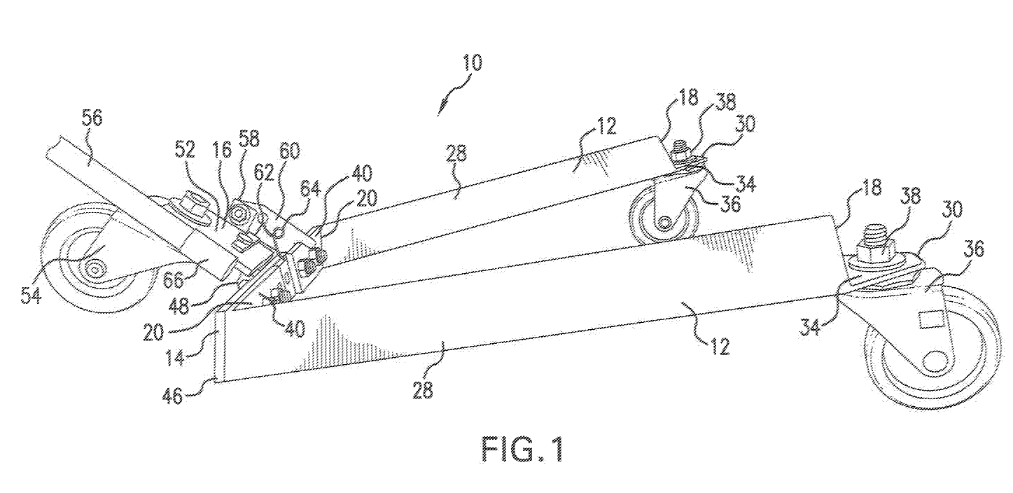

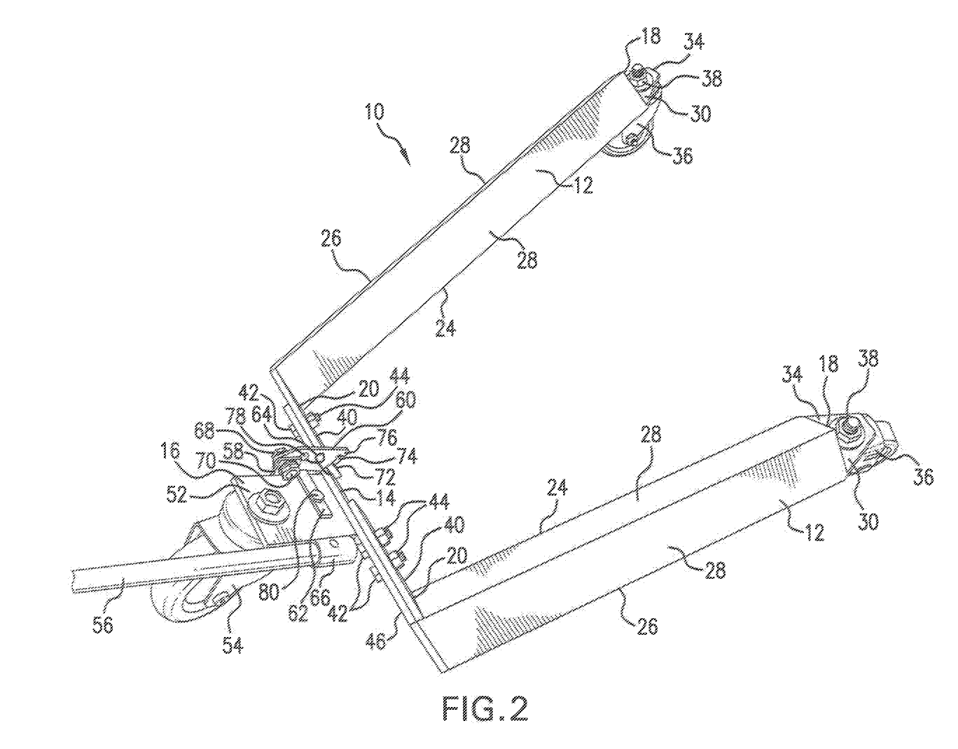

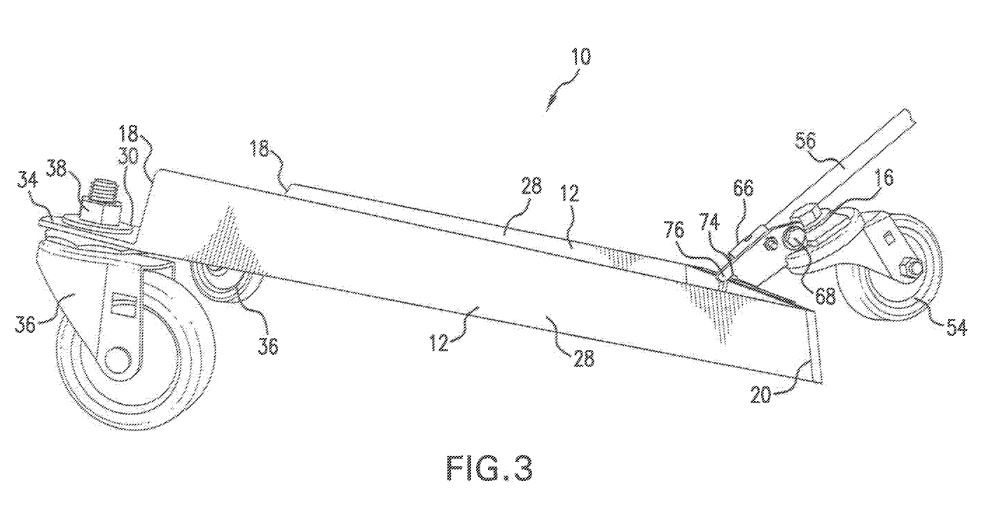

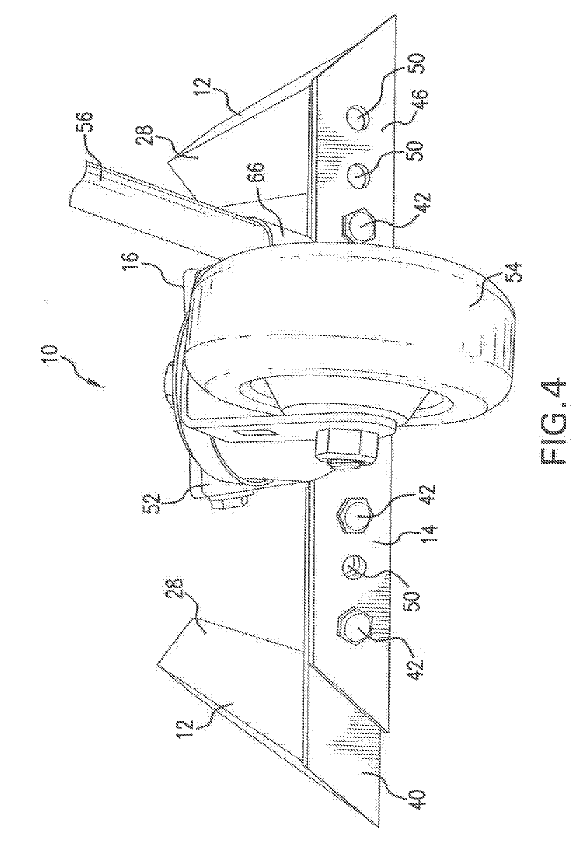

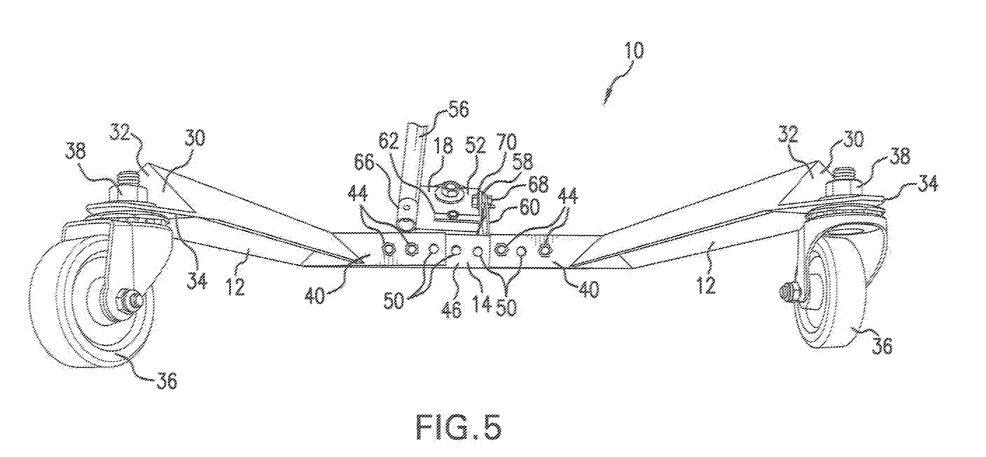

Referring now to FIGS. 1 through 7, a preferred embodiment of the rolling motorcycle stand 10 is shown. The motorcycle stand 10 of the present invention comprises two lift arms 12, a base assembly 14, and a lift assembly 16.

The lift arms 12 of the motorcycle stand 10 extend from the base assembly 14 at angle slightly less than ninety (90) degrees, such that at the outer ends 18 of the lift arms 12 are further apart than the inner ends 20 of the lift arms 12 nearest the base assembly 14. The angled configuration of the lift arms 12 allows the motorcycle stand 10 to be used with a variety of wheel sizes and also makes it easier to roll the motorcycle stand 10 (in its lowered configuration as best shown in FIGS. 1 through 5) beneath a wheel 22 of a motorcycle or similar vehicle. While any angle between the lift arms 12 and the base assembly 14 may be selected in accordance with the range of wheel sizes that the motorcycle stand 10 will be used with, in one embodiment of the present invention the angle between the lift arms 12 and the base assembly 14 is approximately 79 degrees.

The length of the lift arms 12 may be selected according to the range of wheel sizes the motorcycle stand 10 will be used with, with longer lengths being usable with a wider range of wheels but also typically extending further beyond the wheel 22 when the motorcycle stand 10 is used with smaller wheels (thus making it more difficult to use the stand to shift the motorcycle closer to a wall or other fixed object). In one preferred embodiment of the present invention, the lift arms 12 have a length of approximately 14.625 inches on the longer inner edge 24 of the lift arms 12 and a length of approximately 14.25 inches on the shorter outer edge 26 of the lift arms 12.

Each lift arm 12 comprises two lift members 28 constructed of high strength material, such as steel or another metal, perpendicularly attached to each other, thereby creating a triangular-type configuration when the lift arms 12 are viewed end-on. The width of the lift members 28 is selected such that it has sufficient strength to hold a motorcycle without bending, flexing, or otherwise deforming while remaining small enough to allow the lift arms 12 to remain close to the ground when being moved. For example, in one embodiment of the present invention, the lift members 28 have a width of approximately 2 inches.

Each lift arm also includes an end stop 30 located at the outer end 18 of the lift arm 12. The end stop 30 includes a support member 32 and a base member 34. The support member 32 and the base member 34 are attached at an angle of approximately 90 degrees. The support member 32 has a substantially triangular shape, such that the shape of the support member 32 corresponds to the angle between the lift members 28, and is attached to the lift members 28 of the lift arm 12 such that the support member 32 is perpendicular to the lift members 28 at the outer end 18 of the lift arm 12.

The base member 34 extends from the outer end 18 of the lift arm 12 and includes a rotating castor 36 that extends downward from the base member 34. The rotating castor 36 extends through the base member 34 and is held in place with a nut 38. The rotating castor 36 is allowed to rotate an entire 360 degrees, so that the motorcycle stand 10 may be easily moved in any direction.

Each lift arm 12 also includes an arm support 40 located at the inner end 20 of the lift arm 12. The arm support 40 is attached to the lift members 28 and allows the lift arms 12 to be attached to the base assembly 14. A plurality of bolts 42 extend through the arm support 40 to attach the lift arms 12 to the base assembly 14 using corresponding nuts 44. While one end of the arm support 40 typically has a rectangular configuration, the other end of the arm support 40, which is adjacent to the outer edge 18 of the lift arm 12 typically has an angled configuration such that it matches the angle of the lift member 28 on that side.

The base assembly 14 of the motorcycle stand 10 includes the lift base 46 and a hinge 48 that attaches the base assembly 14 to the lift assembly 16. The lift base 46 is a single piece of material having angled ends that correspond with the angle of the lift members 28 of the lift arms 12. The bolts 42 of the lift arms 12 extend through the lift arms 12 and the base assembly 14 and then corresponding nuts 44 are used to secure the lift arms 12 to the base assembly 14. Preferably, at least two bolts 42 are used in order to provide a high-strength connection between the lift arms 12 and the base assembly 14.

Optionally, the base assembly 14 may define two or more additional apertures 50 through the base assembly 14 to allow the distance between the lift arms 12 to be adjusted by removing the nuts 44 and bolts 42 from the base assembly 14, shifting the lift arms 12 laterally along the base assembly 14, and then extending the bolts 42 through a different set of apertures 50 such that the lift arms 12 are closer together or further apart. This allows the user to adjust the configuration of the lift arms 12 so that the lift arms 12 and the motorcycle stand 10 best fit the wheel 22 of the user's motorcycle.

The lift assembly 16 includes a base 52, a rotating castor 54, a lever 56, a lift lock support 58, a lift lock 60, a lift lock release 62, and a lift lock release spring 64.

The base 52 of the lift assembly 16 is attached to the base assembly 14 through the hinge 48. The hinge 48 allows the base 52 of the lift assembly 16 to be rotated relative to the base assembly 14.

The base 52 includes a cylindrical lever receptacle 66 which is typically located opposite the lift lock support 58, lift lock 60, lift lock release 62, and lift lock release spring 64. However, the lever receptacle 66 may alternatively be located adjacent to the lift lock support 58, lift lock 60, lift lock release 62, and lift lock release spring 64 without affecting the operation of the motorcycle stand 10.

The lever 56 of the lift assembly 16 is received by the lever receptacle 66 and then is secured within the lever receptacle 66 using a screw or small bolt and nut. Optionally, the lever 56 may be configured to allow the lever 56 to be removably secured within the lever receptacle 66 to make storage of the motorcycle stand 10 when not in use slightly easier. For example, the lever 56 can be configured to snap into the lever receptacle 66 when the user desires to use the motorcycle stand 10 and then can be pulled back out of the lever receptacle 66 when the user is finished using the motorcycle stand 10.

The lever 56 is preferably cylindrical in shape and, more preferably, is a hollow cylinder.

The length of the lever 56 may be selected based upon the range of weights that the motorcycle stand 10 will be used with. If the motorcycle stand 10 will be used with heavier motorcycles or other vehicles, then a longer lever may be desirable. Likewise, when the motorcycle stand 10 will be used with lighter motorcycles, scooters, and the like, a shorter lever 56 may be utilized. For example, for a motorcycle stand 10 that will be used with typical motorcycles, a lever 56 having a length of approximately 11 inches may be used.

The lift lock support 58 is perpendicularly attached to the base 52, such that the lift lock support 58 extends upward from the base 52. Typically, the lift lock support 58 is welded to the base 52, but alternatively may be attached to the base 52 in any way known in the art.

A bolt 68 extends through the lift lock support 58 and the lift lock 60 and then is held in place by a nut 70, thereby attaching the lift lock 60 to the lift lock support 58. The lift lock 60 is attached to the lift lock support 58 in such a way that the lift lock 60 may still be rotated relative to the lift lock support 58.

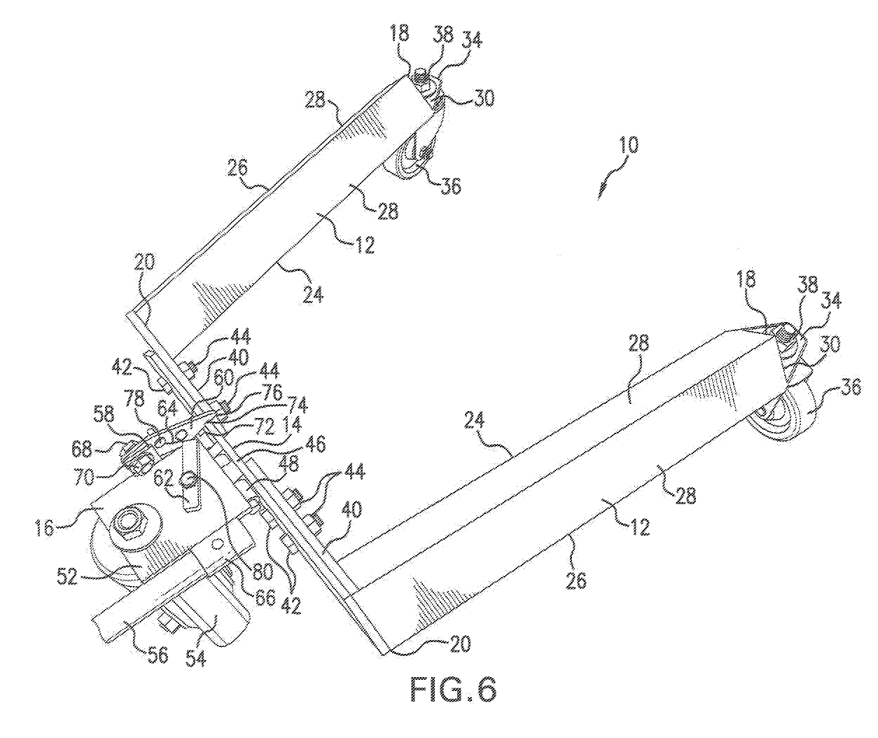

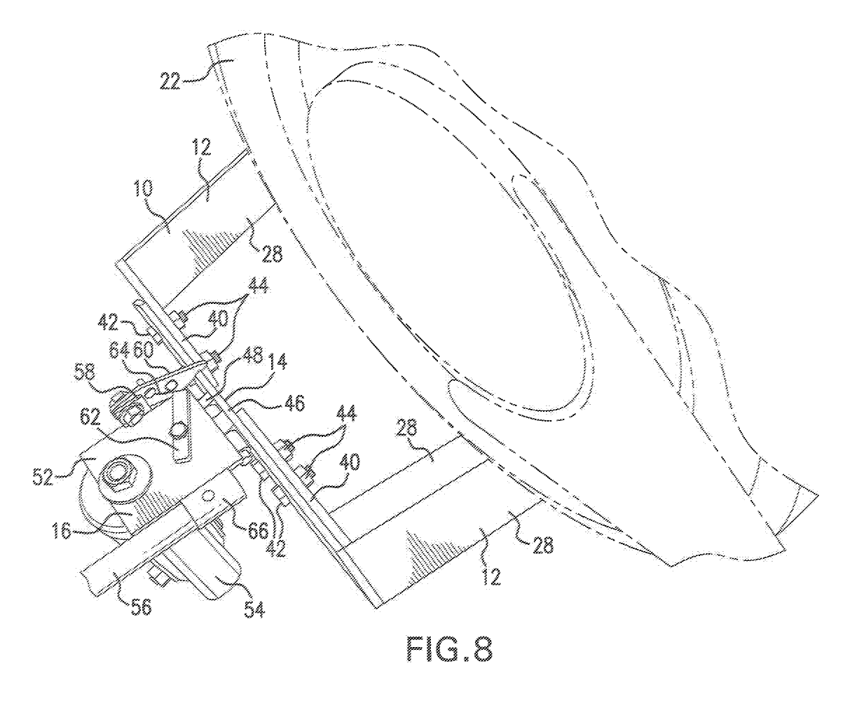

The lift lock 60 includes an angled portion 72, a locking notch 74, a lock stop 76, and the lift lock release spring 64. The angled portion 72 allows the lift lock 60 to slide along the upper surface of the base assembly 14 when the motorcycle stand 10 is being shifted from its lowered configuration (as shown in FIGS. 1 through 5) to its raised configuration (as shown in FIGS. 6 and 8) and is located on the lower edge of the lift lock 60 adjacent to the base assembly 14.

The locking notch 74 is located adjacent to the angled portion 72 of the lift lock 60 and comprises a small notch that projects inward toward the center of the lift lock 60. The width and depth of the locking notch 74 is sized such that the upper edge of the base assembly 14 is received by the locking notch 74 when the motorcycle stand 10 is in its raised configuration. For example, in one embodiment of the present invention the base assembly 14 has a width of approximately 0.25 inches and the locking notch 74 has a depth of approximately 0.125 inches and a width of approximately 0.25 inches.

The lock stop 76 of the lift lock 60 projects slightly from the upper end of the lift lock 60 adjacent to the base assembly 14 and is located adjacent to the locking notch 74. The lock stop 76 projects past the locking notch 74, such that when the upper edge of the base assembly 14 is received in the locking notch 74 the lock stop 76 comes to rest on the inner surface of the base assembly 14, thereby preventing the edge of the base assembly 14 from slipping upward out of the locking notch 74.

The lift lock 60 also includes the lift lock release spring 64, which is located on the surface of the lift lock 60 facing lift lock support 58 and the base 52 and is attached to the lift lock 60 using a small screw or bolt 78. Preferably, the lift lock spring 64 is a torsion spring, but any similar type of spring known in the art may alternatively be used. One arm of the lift lock release spring 64 is attached to the lift lock 60 while the other arm of the lift lock release spring extends toward and comes into contact with the base 52 of the lift assembly 16.

The lift lock release 62 is attached to the base 52 of the lift assembly 16 with a small bolt or screw 80, but is allowed to rotate relative to the base 52. The lift lock release 62 has either a straight configuration or a roughly L-shaped configuration having one longer side and one shorter side. The lift lock release 62 is located on the base 52 of the lift assembly 16 such that when one side is rotated away from the lift lock support 58, the other side of the lift lock release 62 rotates toward the lift lock 60 and comes into contact with the lift lock release spring 64. As the lift lock release 62 continues to rotate, the second side moves under the arm of the lift lock release spring 64 that extends toward the base 52, thereby causing the lift lock release spring 64 to put upward pressure on the lift lock 60. As the lift lock 60 moves upward it disengages from the base assembly 14, thereby allowing the hinge between the lift assembly 16 and the base assembly 14 to operate freely, thereby lowering the motorcycle stand 10 from its raised position to its lowered position. Once the lift lock 60 has been disengaged from the base assembly 14, the lift lock release 62 is rotated back to its starting position, such that the second side of the lift lock release 62 is positioned between the arm of the lift lock release spring 64 that extends toward the base 52 and the base assembly 14.

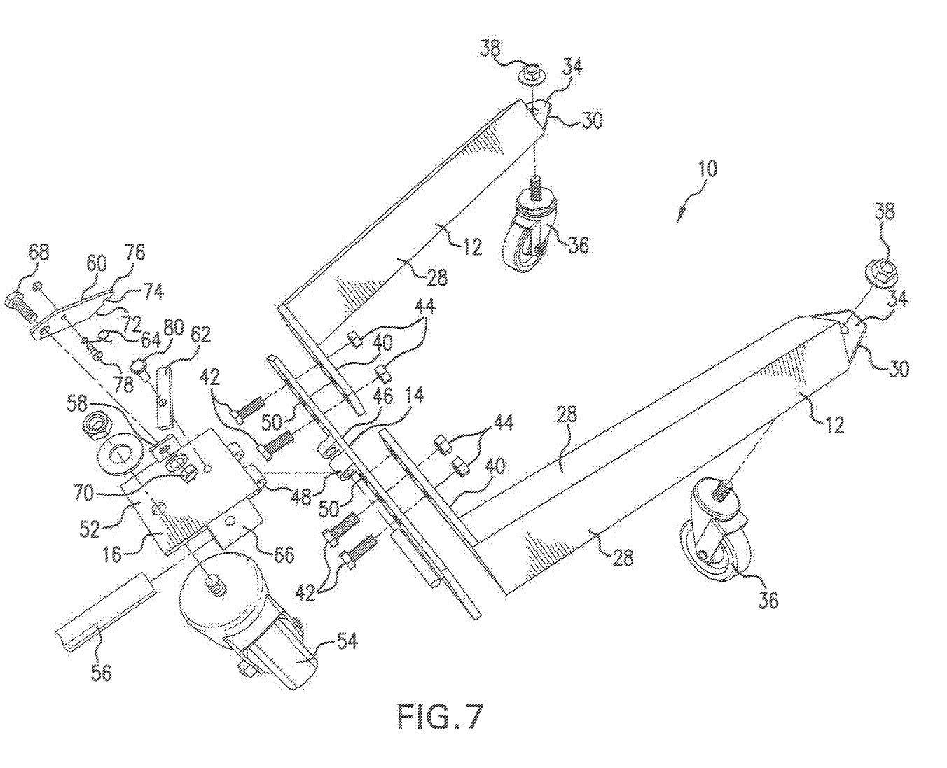

The various individual components and pieces of the motorcycle stand 10 of the present invention may best be seen in FIG. 7, which shows an exploded view of the motorcycle stand 10.

Preferably, the motorcycle stand 10 of the present invention is constructed of a high strength metal, such as steel (except for the wheels of the rotating castor wheels, which typically are high-strength plastic), to allow the motorcycle stand 10 to safely support the weight of the motorcycle or other vehicle that it is being utilized with. Alternatively, the motorcycle stand 10 may be constructed of any other material with sufficient strength to hold the desired weight of the motorcycle or other vehicle that the motorcycle stand 10 will be used with. For example, in some cases other metals, high strength plastics, and the like may be used to construct the motorcycle stand 10.

In order to use the motorcycle stand 10, the user places the motorcycle stand 10 on the ground near the motorcycle or other vehicle that the motorcycle stand 10 is to be used with. The motorcycle stand 10 is then shifted to its lowered position by rotating the lift lock release 62, such that the lift lock release 62 moves under the lift lock release spring 64 and puts upward pressure on the lift lock 60. The user then puts a small amount of downward pressure on the lever 56 so that the base assembly 14 begins to shift out of the locking notch 74 of the lift lock 60, thereby allowing the lift lock release spring 64 to rotate the lift lock 60 upward and disengaging it from the base assembly 14. The motorcycle stand 10 is then allowed to shift into its lowered configuration, where the lower edge of the base assembly 14 comes into contact with the ground. The motorcycle stand 10 is then rolled into position on the rotating castors 36 of the lift arms 12 and the rotating castor 54 of the lift assembly 16, while the portion of the base assembly 14 that is in contact with the ground is allowed to slide along the surface of the ground.

The motorcycle stand 10 is positioned such that one of the lift arms 12 is in front of the wheel 22 of the motorcycle or other vehicle and the other lift arm 12 is located in back of the wheel 22. The motorcycle stand 10 is then rolled directly toward the motorcycle or other vehicle, thereby causing the lift arms 12 to move under the wheel 22, until the lift arms 12 come into contact with the surface of the wheel 22. The angled configuration of the lift arms 12 allows the user to roll the lift arms 12 passed the wheel 22 before the lift arms 12 actually come into direct contact with the wheel 22.

Once the motorcycle stand 10 is in position under the wheel 22, the user presses the lever 56 of the lift assembly 16 downward toward the ground. Typically, the user would use the user's foot to operate the lever 56, but alternatively the user may use his or her hands. As the lever 56 shifts toward the ground, the lever 56 causes the lift assembly 16 to rotate relative to the base assembly 14 and the lift arms 12 through the operation of the hinge 48, which cases the base assembly 14 to shift upward off of the ground. As the base assembly 14 shifts upward, the lift arms 12 lift the wheel 22 off of the ground until the wheel 22 is no longer in direct contact with the ground.

As the lift assembly 16 rotates relative to the base assembly 14, the lift lock 60 slides along the upper edge of the base assembly 14 until the upper edge of the base assembly 14 comes into contact with and shifts into the locking notch 74 and the stop 76 comes into contact with the base assembly 14.

Once the upper edge of the base assembly 14 is within the locking notch 74, the user releases the lever 56 and the lift lock 60 engages the upper edge of the base assembly 14 and the lifting assembly 16 and base assembly 14 and locks the motorcycle stand 10 into its raised position as best seen in FIG. 8.

The user than may move the wheel 22 of the motorcycle or other vehicle using the rotating castors 36 of the lift arms 12 and the rotating castor 54 of the lift assembly 16 until the wheel 22 is in the desired location.

Once the wheel 22 is in the desired location, the user rotates the lift lock release 62 until the shorter side 26 is under the lift lock release spring 64, such that the lift lock release spring 64 begins to put upward pressure on the lift lock 60. The user then puts a small amount of downward pressure on the lever 56 so that the base assembly 14 begins to shift out of the locking notch 74 of the lift lock 60, thereby allowing the lift lock release spring 64 to rotate the lift lock 60 upward and disengaging it from the base assembly 14. The user then releases all pressure from the lever 56 and the motorcycle stand 10 is allowed to shift into its lowered configuration, where the lower edge of the base assembly 14 comes back into contact with the ground. When the motorcycle stand 10 returns to its lowered configuration, the wheel 22 also comes to rest on the ground. When the motorcycle stand 10 is in its lowered configuration, the user pulls the motorcycle stand 10 out from under the wheel on the rotating castors 36 of the lift arms 12 and the rotating castor 54 of the lift assembly 16 (while the portion of the base assembly 14 that is in contact with the ground is allowed to slide along the surface of the ground).

Through the use of the motorcycle stand 10 of the present invention, the user may move the wheel 22 of the motorcycle or other vehicle from one place to another in any direction, allowing the motorcycle or other vehicle to be positioned in locations where it would be difficult or impossible to drive the motorcycle or other vehicle into and park. Thus, the present invention allows users to make more efficient use of space in places such as garages and the like. That is, the motorcycle stand 10 of the present invention allows a user to move a motorcycle or other vehicle laterally to, for example, move it closer to the wall of the garage or similar structure to increase the amount of space available for the parking of other vehicles.

It will be recognized by one skilled in the art that the size, configuration, or dimensions of the rolling motorcycle stand 10 of the present invention may be adjusted to allow for use with motorcycles or other motor vehicles of various sizes. Likewise, it will be recognized by one skilled in the art that the materials from which the rolling motorcycle stand 10 of the present invention is made may be varied without departing from the scope of the present invention.

While the invention has been described in the specification and illustrated in the drawings with reference to certain preferred embodiments, it will be understood by those skilled in the art that various changes may be made and equivalents may be substituted for elements thereof without departing from the scope of the present invention as defined in the appended claims. In addition, many modifications may be made to adapt to a particular situation or material to the teachings of the invention, as defined in the appended claims, without departing from the essential scope thereof. Therefore, it is intended that the present invention not be limited to the particular embodiments illustrated by the drawings and described in the specification as the best modes presently contemplated for carrying out the present invention, but that the present invention will include any embodiments falling within the description of the appended claims.

What is claimed is:

1. A rolling motorcycle stand comprising:
a first lift arm, wherein the first lift arm includes a first rotating castor at a first end of the first lift arm;
a second lift arm, wherein the second lift arm includes a second rotating castor at a first end of the second lift arm;
a base assembly, wherein the base assembly is secured to the first lift arm at a second end of the first lift arm and is secured to the second lift arm at a second end of the second lift arm;
a lift assembly, wherein the lift assembly includes a lever for operating the rolling motorcycle stand, a third rotating castor, and a lift lock assembly; and
a hinge, wherein a first side of the hinge is secured to the base assemble and the second side of the hinge is secured to the lift assembly, such that the base assembly and lift assembly may be rotated relative to each other;
wherein the lift lock assembly of the lift assembly engages the base assembly when the rolling motorcycle stand is in its raised configuration and wherein the lift lock assembly is disengaged from the base assembly when the rolling motorcycle stand is in its lowered configuration.

2. The rolling motorcycle stand of claim 1, wherein the first lift arm includes a first end stop located at the first end of the first lift arm and the first rotating castor is secured to the first end stop and wherein the second lift arm includes a second end stop located at the first end of the second lift arm and the second rotating castor is secured to the second end stop.

3. The rolling motorcycle stand of claim 1, wherein the first lift arm and the second lift arm have a triangular cross section.

4. The rolling motorcycle stand of claim 1, wherein the distance between first end of the first lift arm and the first end of the second lift arm is greater than the distance between the second end of the first lift arm and the second end of the second lift arm.

5. The rolling motorcycle stand of claim 1, wherein the second end of the first lift arm and the second end of the second lift arm include a plurality of apertures and the base assembly includes a plurality of apertures and wherein the first lift arm and second lift arm are secured to the base assembly by connectors that extend through the apertures of the first lift arm and second lift arm and the apertures of the base assembly.

6. The rolling motorcycle stand of claim 5, wherein the distance between the first lift arm and the second lift arm may be varied by selecting the apertures of the first lift arm and second lift arm and the apertures of the base assembly through which the connectors extend.

7. The rolling motorcycle stand of claim 1, wherein the rolling motorcycle stand is constructed of steel.

8. The rolling motorcycle stand of claim 7, wherein the first rotating castor, second rotating castor, and third rotating castor each include a wheel portion and the wheel portions of the first rotating castor, second rotating castor, and third rotating castor are constructed of plastic.

9. The rolling motorcycle stand of claim 7, wherein the first rotating castor, second rotating castor, and third rotating castor each include a wheel portion and the wheel portions of the first rotating castor, second rotating castor, and third rotating castor are constructed of rubber.

10. The rolling motorcycle stand of claim 1, wherein the lift lock assembly comprises a lift lock, a lift lock release, and a lift lock release spring.

11. The rolling motorcycle stand of claim 10, wherein the lift lock includes a locking notch that engages the base member and a lift lock stop that extends from the lift lock and comes into contact with the base assembly when the lift lock assembly engages the base assembly.

12. The rolling motorcycle stand of claim 11, wherein the lift lock spring is a torsion spring.

13. The rolling motorcycle stand of claim 12, wherein the lift lock assembly is disengaged from the base assembly be rotating the lift lock release into contact with the lift lock release spring.

14. The rolling motorcycle stand of claim 1, wherein the lift assembly includes a receptacle for receiving the lever and wherein the lever is removably secured to the lift assembly by inserting the lever into the receptacle.

15. The rolling motorcycle stand of claim 1, wherein the lift assembly includes a base and a lift lock support, the lift lock support extends vertically from the base, and the lift lock is secured to the lift lock support such that the lift lock may rotate relative to the lift lock support.
